(19) United States
(12) Patent Application Publication
(10) Pub. No.: US 2026/0025635 A1
(43) Pub. Date: Jan. 22, 2026

(54) APPARATUS AND METHOD FOR GEOFENCING SERVICE

(71) Applicant: ELECTRONICS AND TELECOMMUNICATIONS RESEARCH INSTITUTE, Daejeon (KR)

(72) Inventors: Seung-Hee Oh, Daejeon (KR); Hyunjoo Kang, Daejeon (KR); Sang Lim Ju, Daejeon (KR)

(21) Appl. No.: 18/987,692

(22) Filed: Dec. 19, 2024

(30) Foreign Application Priority Data
Jul. 18, 2024 (KR) 10-2024-0095340
Nov. 4, 2024 (KR) 10-2024-0154369

(51) Int. Cl. H04W 4/021

(52) U.S. Cl. CPC H04W 4/021

(57) ABSTRACT

Provided is an apparatus for geofencing service, the apparatus including: a memory; and a processor functionally connected to the memory, wherein the processor, when polygonal zone information related to a geographic area for transmitting specified information is set, reduces a number of sides of a polygon according to the set polygonal zone information using external extension lines of each side of the polygon, determines an area corresponding to the polygon having the reduced number of sides as a target area for transmitting the specified information, and stores information related to the determined target area in the memory.

### CROSS-REFERENCE TO RELATED APPLICATIONS

This application claims priority to and the benefit of Korean Patent Application No. 10-2024-0095340, filed on Jul. 18, 2024, and No. 10-2024-0154369, filed on Nov. 4, 2024, the disclosure of which is incorporated herein by reference in its entirety.

### BACKGROUND

### 1. Field of the Invention

Various embodiments disclosed in this document relate to geofencing service technology.

### 2. Discussion of Related Art

In order to minimize life and property damage caused by natural disasters, such as heavy rain, tsunamis, earthquakes, lightning, and volcanic eruptions, as well as man-made disasters, such as fires, collapses, explosions, traffic accidents, environmental pollution accidents, and chemical, biological, and radiological disasters, governments around the world are making significant efforts to establish emergency alert message services.

With the increasing penetration rate of mobile phones, most emergency alert message services are provided in the form of emergency alert messages via mobile phones. Emergency alert messages are provided by emergency alert message issuers transmitting emergency text messages to mobile phones through telecommunication operators. The emergency alert messages are able to deliver disaster information to all mobile phones connected to base stations in each region with a single issuance, and therefore are rapid and efficient.

### SUMMARY OF THE INVENTION

However, since the locations of base stations vary between telecommunication providers and the transmission range of emergency alert messages are extensive, users in adjoining regions face the inconvenience of receiving unneeded emergency alert messages. To resolve this inconvenience, users may disable disaster message alarms, which may result in missing needed emergency alert messages.

The present disclosure is directed to providing an apparatus and method for geofencing service that are capable of efficiently setting area information for transmitting information, such as emergency alert messages.

According to an aspect of the present disclosure, there is provided an apparatus for geofencing service, which includes: a memory; and a processor functionally connected to the memory, wherein the processor, when polygonal zone information related to a geographic area for transmitting specified information is set, reduces a number of sides of a polygon according to the set polygonal zone information using external extension lines of each side of the polygon, determines an area corresponding to the polygon having the reduced number of sides as a target area for transmitting the specified information, and stores information related to the determined target area in the memory.

According to an aspect of the present disclosure, there is provided an apparatus for geofencing service, which includes: a communication module; and a processor functionally connected to the communication module, wherein the processor, upon receiving a geographical area related to transmission of specified information through the communication module, sets polygonal zone information including the geographical area, reduces a number of sides of a polygon according to the set polygonal zone information using external extension lines of each side of the polygon, determines a geographical area corresponding to the polygon having the reduced number of sides as an area for transmitting the specified information, and transmits information about the determined geographical area to an external electronic device through the communication module.

According to an aspect of the present disclosure, there is provided a method for geofencing service, which is performed in at least one process, and which includes: setting polygonal zone information including a selected geographical area in relation to transmission of specified information; reducing a number of sides of a polygon according to the set polygonal zone information using external extension lines of each side of the polygon; determining a geographical area corresponding to the polygon having the reduced number of sides as a transmission target area of the specified information and storing information about the determined transmission target area.

The technical objectives of the present disclosure are not limited to the above, and other objectives that are not described above may become apparent to those of ordinary skill in the art based on the following description and the accompanying drawings.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 shows an implementation environment of an apparatus for geofencing service according to an embodiment;

FIG. 2 shows a configuration diagram of an apparatus for geofencing service according to an embodiment;

FIG. 3 shows an exemplary diagram of setting an alarm zone according to a geofencing service according to an embodiment;

FIG. 4 shows an exemplary diagram of forming an extension line of a polygon according to an embodiment;

FIG. 5 shows an exemplary diagram of calculating the area of a shape formed by extension lines of a polygon according to an embodiment;

FIG. 6 and FIG. 7 show examples of a polygon side number reduction technique according to an embodiment;

FIG. 8 shows a flowchart of a method for geofencing service according to an embodiment; and

FIG. 9 shows a detailed flowchart of a method for geofencing service according to an embodiment.

In relation to the description of the drawings, identical or similar reference numerals may be used for identical or similar components.

### DETAILED DESCRIPTION OF EXEMPLARY EMBODIMENTS

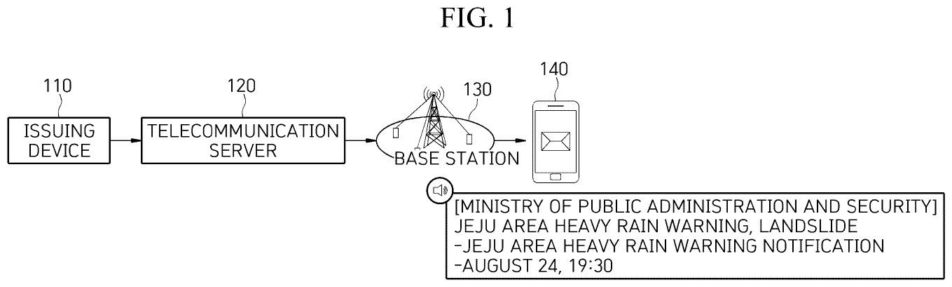

FIG. 1 shows an implementation environment of an apparatus for geofencing service according to an embodiment.

Referring to FIG. 1, an issuing device 110 may issue a emergency alert message for an alarm zone related to a disaster occurrence area at the request of a disaster information issuer. The issuing device 110 may set the alarm zone in units of geometric shapes and transmit latitude and longitude coordinates together with content of disaster information to a telecommunication server 120.

The telecommunication server 120 matches the latitude and longitude information of a target area TA or a base station covering the alarm zone. And the telecommunication server 120 transmits a disaster information text message to a user terminal 140 within coverage of a base station 130 for which the latitude and longitude information matches. For example, the telecommunication server 120, upon identifying location information of an alarm zone related to disaster information, extracts base station information related to the location information and then transmits disaster information to the extracted base station 130.

The base station 130 may transmit disaster information to the user terminal 140 accessed thereto.

Additionally, each user terminal 140 may selectively display disaster information based on the current location. For example, the user terminal 140 may receive disaster information and alarm area coordinate information (e.g., latitude and longitude information) through the base station 130, and based on alarm zone information, may identify whether the current location of each user terminal 140 is within the alarm zone. When the current location is within the alarm zone, the user terminal 140 may output (using display or speaker) disaster information. When the alarm zone is a complex polygon area (e.g., a polygonal area with many vertices), the user terminal 140 needs to perform a large number of operations to identify whether the current location is within the alarm zone. However, the issuing device 110 according to an embodiment may reduce a number of sides of a polygon corresponding to the alarm zone to simplify coordinate values corresponding to the alarm zone. This will be described below.

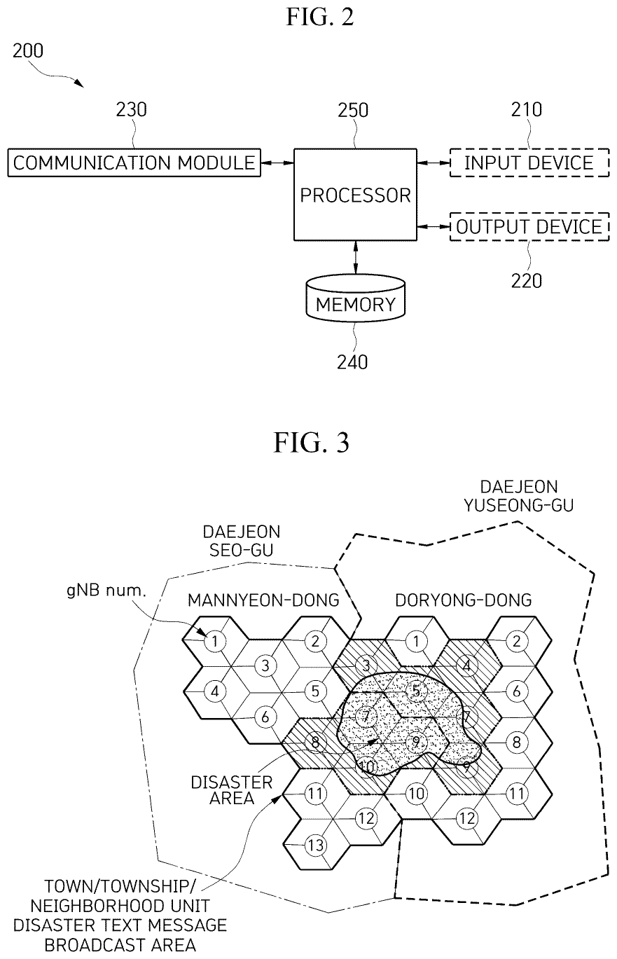

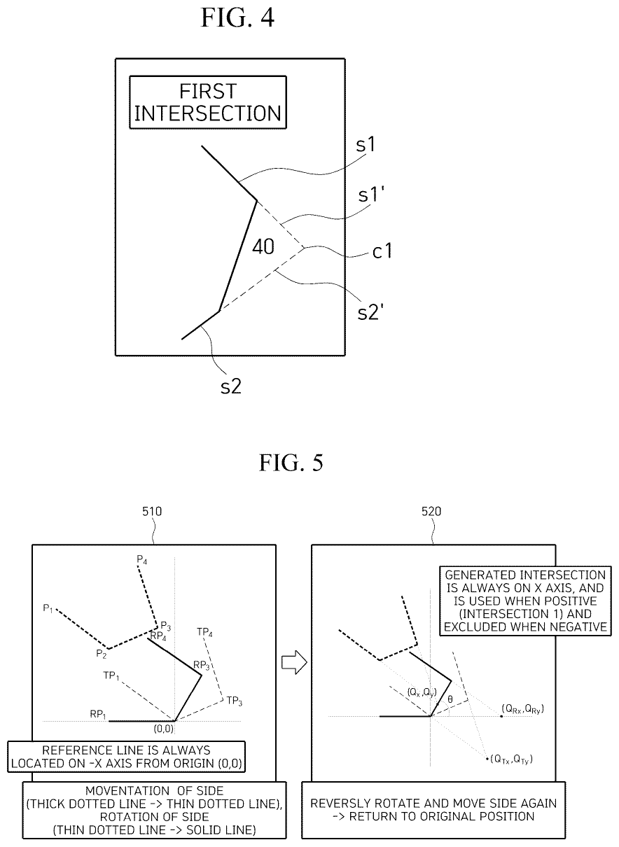

FIG. 2 shows a configuration diagram of an apparatus for geofencing service according to an embodiment, FIG. 3 shows an exemplary diagram of setting an alarm zone according to a geofencing service according to an embodiment, FIG. 4 shows an exemplary diagram of forming an extension line of a polygon according to an embodiment, and FIG. 5 shows an exemplary diagram of calculating an area of a shape formed by an extension line of a polygon according to an embodiment.

Referring to FIG. 2, an apparatus 200 for geofencing service according to an embodiment (e.g., an issuing device 110 shown in FIG. 1) may include a communication module 230, a memory 240, and a processor 250. In an embodiment, in the apparatus 200 for geofencing service, some components may be omitted or additional components may be added. For example, the apparatus 200 for geofencing service may include an input device 210 and an output device 220. In addition, some of the components of the apparatus 200 for geofencing service may be combined into a single component, but may perform the same functions of the components before the combination. The apparatus 200 for geofencing service may be included in, for example, the issuing device 110. In various embodiments, the apparatus 200 for geofencing service may be included in at least one of the telecommunication server 120 or the base station 130. In FIG. 2, a case in which the apparatus 200 for geofencing service is at least a part of the issuing device 110 is described as an example.

The input device 210 may receive user input using the apparatus 200 for geofencing service. The input device 210 may include, for example, an input detection circuit of at least one of a touchscreen, a mouse, and a button. The user input may be, for example, an input for setting/selecting an administrative district (e.g., a town, a township, or a neighborhood) in which to issue disaster information.

The output device 220 may visually or audibly output at least one type of data among symbols, numbers, or text under the control of the processor 250. The output device 220 may include, for example, at least one of a liquid crystal display, an organic light emitting diode (OLED), a touchscreen display, and a speaker. For example, the output device 220 may present information related to at least one of polygon information setting, reduction of a number of sides, and (alarm) target region (transmission target region) under the control of the processor 250.

The communication module 230 may support the establishment of a communication channel or a wireless communication channel between the apparatus 200 for geofencing service and another device (e.g., the base station 130), and the performance of communication through the established communication channel. The communication channel may include, for example, at least one communication channel among a local area network (LAN), fiber to the home (FTTH), a digital subscriber line (xDSL), wireless broadband (WiBro), Wifi, 3G, 4G, 5G, or 6G.

The memory 240 may include various types of volatile or nonvolatile memories. For example, the memory 240 may include a read only memory (ROM) and a random access memory (RAM). In an embodiment, the memory 240 may be located inside or outside the processor 250, and the memory 240 may be connected to the processor 250 through various known means. The memory 240 may store various types of data used by at least one component (e.g., the processor 250) of the apparatus 200 for geofencing service. The data may include, for example, input data or output data for software and instructions related thereto. For example, the memory 240 may store at least one instruction and data for applying a polygonal side number reduction technique related to an alarm zone of disaster information.

The processor 250 may control at least one other component (e.g., a hardware or software component) of the apparatus 200 for geofencing service and may perform various data processing processes or operations. The processor 250 may include, for example, at least one of a central processing unit (CPU), a graphics processing unit (GPU), a microprocessor, an application processor, an application specific integrated circuit (ASIC), and a field programmable gate array (FPGA), and may have a plurality of cores.

According to an embodiment, the processor 250 may identify polygonal zone information (convex polygonal zone information) related to a geographic area for which disaster information (specified information) is transmitted. For example, when the processor 250 identifies alarm zone information (e.g., the name of a neighborhood or a town) input by a user (e.g., a emergency alert message issuer) through the input device 210, the processor 250 may set a polygonal zone related to the identified alarm zone information. Referring to FIG. 3, the user may determine an alarm zone (e.g., a radius of 1 km of a disaster range) that requires evacuation/preparation due to a disaster occurring in the disaster range, and input the determined alarm zone information (e.g., an area displayed with a pattern in FIG. 3) through the input device 210. The processor 250 may set polygonal zone information (e.g., an area inside a thick solid outline in FIG. 3 (a emergency alert message broadcast/transmission range)) corresponding to the alarm zone information. Since the alarm zone is a polygonal (or circular) zone (see the hatched part in FIG. 3 with numerous vertices), the processor 250 may set the polygonal zone information based on the alarm zone information.

According to an embodiment, the processor 250 may generate intersections of external extension lines on all sides of a polygon according to the polygonal zone information. For example, the processor 250 may form external extension lines on the left and right of each side of the polygon and generate an intersection of the external extension lines. For example, referring to a part of a polygon shown in FIG. 4, the processor 250 may form an external extension line s1′ from a first side s1 of the polygon, and an external extension line s2′ from a second side s2 of the polygon, to generate a first intersection cl at which the first extension line s1′ and the second extension line s2′ intersect.

According to an embodiment, the processor 250 may form a shape 40 by the intersection of the extension lines s1′, s2′ of each side of the polygon s1, s2, and may calculate the area of the formed shape 40.

As in operation 510 of FIG. 5, the processor 250 may move and rotate the polygon such that each side is based on the origin and the −x axis to easily calculate the area of the formed shape. For example, the processor 250 may move a polygon P₁, P₂, P₃, and P₄ of FIG. 5 such that one end P₂ of each side (e.g. TP₁ and TP₂) is positioned at the origin (0, 0) of the coordinate axis (see TP₁, TP₂, TP₃, and TP₄ of FIG. 5), and rotate the polygon (TP₁, TP₂, TP₃, and TP₄ of FIG. 5) such that each side (e.g. RP₁ and RP₂) is aligned with the −x axis (see RP₁, RP₂, RP₃, and RP₄).

As in operation 520 of FIG. 5, the processor 250 may identify coordinate values (Q_{Rx}, Q_{Ry}) of an intersection of the extension lines formed from each side of the polygon RP₁, RP₂, RP₃, and RP₄ based on the origin and the −x axis. The processor 250 may calculate the area of a generated shape (a shape formed by the origin, RP₃, and (Q_{Rx}, Q_{Ry})) using the identified x-coordinate value. For example, the processor 250 may calculate the area of the generated shape (the shape formed by the origin, RP₃, and (Q_{Rx}, Q_{Ry})) from the identified x-coordinate value, the angle (θ=180−“∠RP₁OriginRP₃”) and the length of RP₂ to RP₁.

In an embodiment, the processor 250 may move and rotate each side of the polygon to identify the length (the x-coordinate value) of the extension line, and then reversely rotate and move each side of the polygon to restore each side of the polygon to the original position. Accordingly, the processor 250 according to an embodiment may uniformly, regularly, and easily calculate the position of the intersection of the external extension line of the polygon sides and the area increase caused by inclusion of the shape formed by the intersection, and may also reduce the amount of calculation for calculating the area.

According to an embodiment, the processor 250 may include shapes formed by intersections of the external extension lines of the polygon within a specified condition in the polygon in order of a shape with a smallest area, thereby reducing the number of sides of the polygon. Accordingly, the area of the polygon with the reduced number of sides may be enlarged compared to the initially set polygon.

The specified condition may be, for example, a polygon area enlargement threshold (e.g., 10%). In this case, the processor 250 may identify an enlarged area by including shapes formed by intersections of external extension lines of sides of the set polygon in the order of a shape with the smallest area. The processor 250 may reduce the number of sides of the polygon within a range in which the enlarged area is 10% or less of the set polygon.

In an embodiment, the processor 250 may identify the x values of the intersections of the +x-axis direction extension lines of each side and exclude an intersection having a −x value among the intersections of the extension lines of each side.

According to an embodiment, the processor 250 may determine the polygon with the reduced number of sides within a range that satisfies the specified condition as an alarm target area. The processor 250 may transmit alarm target area information (e.g., latitude and longitude information) and disaster information to the telecommunication server 120 through the communication module 230. The alarm target area corresponding to the polygon with a reduced number of sides may have a somewhat increased area, but as the number of sides (or vertices) decreases, the number of coordinate values (e.g., vertex coordinates) representing the target area may be reduced.

Thereafter, the telecommunication server 120 may transmit alarm target area information and disaster information to a plurality of user terminals 140 through at least one base station 130 corresponding to the alarm target area. For example, at least one base station 130 may identify current location information of a plurality of user terminals and transmit disaster information to a plurality of user terminals located in the alarm target area. As another example, some of the plurality of user terminals 140 may be located outside the alarm target area. In this case, the user terminals may not display disaster information even after receiving the disaster information. Accordingly, the apparatus 200 for geofencing service according to an embodiment may reduce the amount of computation in a process of identifying whether the user terminal 140 belongs to an alarm target area based on the current location when the user terminal 140 adopts receiver-based geofencing using an adaptive geofencing technique.

According to various embodiments, the apparatus 200 for geofencing service may also, with respect to a polygon for a geographical area related to provision of personalized information, simplify coordinate values of a transmission target area by reducing a number of sides of a polygon as described above. For example, the processor 250 may apply the polygon side number reduction technique described above to an area to which information, such as marketing information and advertising information, is transmitted. As another example, the processor 250 may collect information on regions of interest of individuals and store the information in the memory 240. The processor 250 may collect and analyze information on regions of interest including information on various measuring devices and sensors installed in the regions of interest. When an emergency or urgent disaster occurs or is predicted and disaster information is provided, the processor 250 may combine information collected from a personal region of interest with basic disaster information and transmit the information as customized disaster information for the user. Accordingly, the apparatus 200 for geofencing service according to an embodiment may increase a user's interest and trust in disaster information while supporting rapid and safe preparation and response in the event of a disaster, thereby minimizing human, material, and economic damage.

As described above, the apparatus 200 for geofencing service according to an embodiment may reduce the indiscriminate transmission of unnecessary disaster information to user terminals through the polygonal coordinate reduction when providing a emergency alert message service based on a location.

In addition, the apparatus 200 for geofencing service according to an embodiment may simplify the coordinate values of the transmission target area (an alarm zone) of disaster information by reducing the number of sides of the polygon, and may accordingly reduce the amount of computation in a process of identifying whether a location is included in the transmission target area, ensuring wide use in various services.

In addition, the apparatus 200 for geofencing service may provide disaster information according to the user's location, thereby addressing the issue of users receiving disaster information of nearby areas far from the user's location, which may lead to the user underestimating the importance of the received disaster information and responding indifferently to the received disaster information or turning off a disaster information reception alarm to some extent.

Furthermore, the apparatus 200 for geofencing service according to an embodiment may reduce the amount of transmission and computation, thereby reducing battery consumption due to unnecessary data reception of the user terminal 140. In particular, during disaster situations, power supply limitations or power outages may occur, and therefore the present disclosure may be more effective.

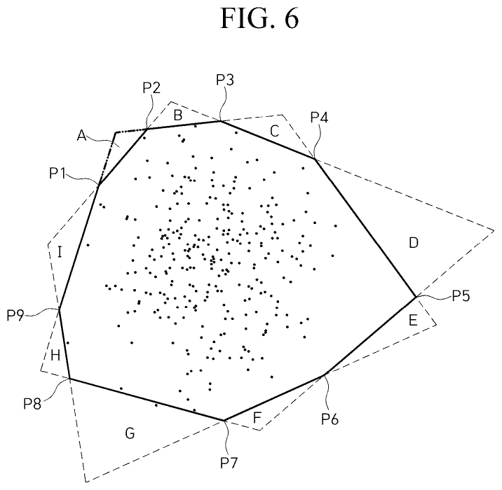

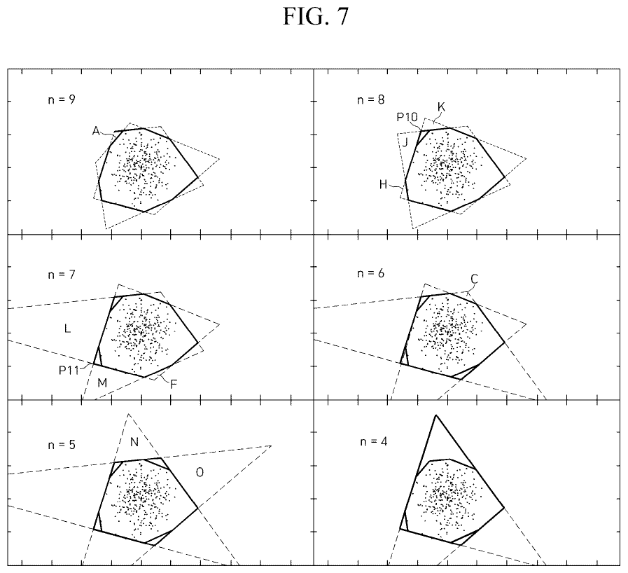

FIG. 6 and FIG. 7 show examples of a polygon side number reduction technique according to an embodiment.

Referring to the case of n=9 in FIG. 6 and FIG. 7, the apparatus 200 for geofencing service may set a convex polygon with 9 sides (a bold solid line, a polygon having vertices P₁ to P₉) that includes all 500 points (e.g., alarm zones).

The apparatus 200 for geofencing service may form external extension lines (see dotted lines) from each side of the convex polygon with 9 sides to generate intersections corresponding to the number of vertices of the initial polygon (the bold solid line of FIG. 6).

The apparatus 200 for geofencing service may enlarge the initial polygon to include a region A with the smallest area among shapes A, B, C, D, E, F, G, H, and I formed by the intersections. Accordingly, the apparatus 200 for geofencing service may determine to reduce the number of sides that constitute the shape A.

Referring to the case of n=8 in FIG. 7, the apparatus 200 for geofencing service may form an octagonal convex polygon by reducing the number of sides forming the shape A. In this case, the apparatus 200 for geofencing service may (not need to generate intersections again for all sides but may) additionally generate intersections of external extension lines only for the left and right sides of a vertex P10 generated by the side number reduction. The apparatus 200 for geofencing service may form two shapes H and K by the additionally generated intersections. The apparatus 200 for geofencing service may determine the reduction of a side that forms the shape H having the smallest area among the shapes J, K, C, D, E, F, G, and H generated by the intersections.

Referring to the case of n=7 in FIG. 7, the apparatus 200 for geofencing service may form a heptagonal convex polygon by reducing the number of sides forming the shape H. The apparatus 200 for geofencing service may generate the intersections of the external extension lines for the left and right sides of a vertex P11 generated by the side number reduction. The apparatus 200 for geofencing service may form two shapes L and M by the additionally generated intersections. The apparatus 200 for geofencing service may determine the reduction of a side that forms the shape C having the smallest area.

In a similar manner, in the case of n=6 and n=5 in FIG. 7, the apparatus 200 for geofencing service may reduce a number of sides forming the shape F in the heptagonal convex polygon and reducing a number of sides forming the shape C in a hexgonal convex polygon to generate a pentagonal convex polygon.

Referring to the case of n=5 in FIG. 7, the apparatus 200 for geofencing service may generate a quadrangular convex polygon by reducing a number of sides forming the shape N with the smallest area in the pentagonal convex polygon.

As shown in FIG. 7, it can be seen that as the number of sides of the polygon is reduced, the area of the polygon is gradually enlarged. Accordingly, the apparatus 200 for geofencing service according to an embodiment may reduce the number of polygon sides while at least one condition among the number of polygon sides and the area enlargement is satisfied. For example, the apparatus 200 for geofencing service may end the reduction of the polygon sides when the number of polygon vertices is less than or equal to a threshold. As another example, the apparatus 200 for geofencing service may end the reduction of the polygon sides when the area of the polygon enlarged by the reduction of the polygon sides is greater than or equal to an enlargement criterion according to a specified condition based on the initial polygon area. The apparatus 200 for geofencing service may determine the final side-reduced polygon as an alarm target area.

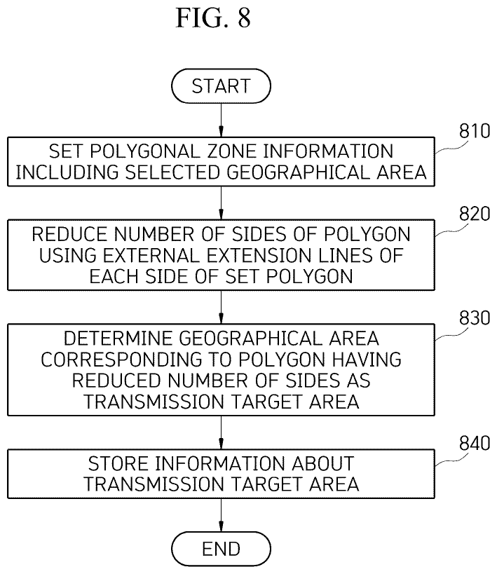

FIG. 8 shows a flowchart of a method for geofencing service according to an embodiment.

Referring to FIG. 8, in operation 810, the apparatus 200 for geofencing service may set polygonal zone information including a selected geographical area in relation to transmission of specified information.

In operation 820, the apparatus 200 for geofencing service may reduce a number of sides of a polygon according to the set polygonal zone information using external extension lines of each side of the polygon.

In operation 830, the apparatus 200 for geofencing service may determine a geographical area corresponding to the polygon having the reduced number of sides as a transmission target area of the specified information.

In operation 840, the apparatus 200 for geofencing service may store information about the determined transmission target area.

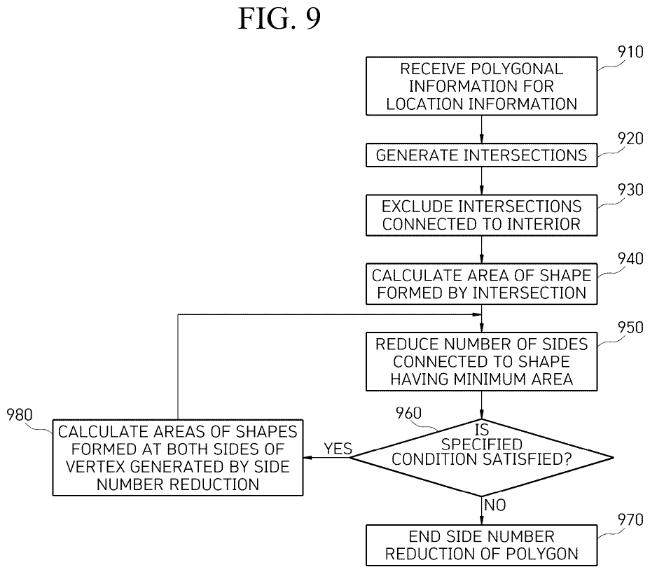

FIG. 9 shows a detailed flowchart of a method for geofencing service according to an embodiment.

Referring to FIG. 9, in operation 910, the apparatus 200 for geofencing service receives polygonal information for location information.

In operation 920, the apparatus 200 for geofencing service may generate intersections of external extension lines at both ends of each side of the polygon.

In operation 930, the apparatus 200 for geofencing service may exclude intersections connected to the interior of the polygon (or facing the interior) from among the generated intersections.

In operation 940, the apparatus 200 for geofencing service may calculate the area of an enlarged polygon by including at least some of the shapes formed by the intersections. For example, the apparatus 200 for geofencing service may calculate the area of a shape generated adjacent to each side of the polygon by the intersection of the external extension lines of the sides of the polygon. The apparatus 200 for geofencing service may, for example, rotate and move a polygon such that each side is aligned with the −x axis and one end of each side is located at the coordinate origin, and detect an x value of the intersection of external extension lines for each side of the rotated and moved polygon. The apparatus 200 for geofencing service may calculate the areas of shapes formed by the intersections of the external extension lines of the polygon sides using the x values.

In operation 950, the apparatus 200 for geofencing service may reduce a number of sides of the polygon connected to a shape having a minimum area. For example, the apparatus 200 for geofencing service may reduce the number of sides connected to the polygon by including the shape having a minimum area in the set polygon. Accordingly, the area of the polygon whose number of sides has been reduced may be enlarged as much as the shape having the minimum area.

In operation 960, the apparatus 200 for geofencing service may identify whether the polygon whose number of sides has been reduced satisfies a specified condition. For example, the apparatus 200 for geofencing service may identify whether at least one condition of a first condition that an area enlargement of the polygon due to the reduction of the number of the sides is within a specified range and a second condition that the number of the sides of the polygon is less than or equal to a specified threshold is satisfied.

In operation 960, when it is confirmed that the polygon whose number of sides is reduced does not satisfies the specified condition, the apparatus 200 for geofencing service may end the reduction of the number of sides of the polygon in operation 970.

On the other hand, when it is confirmed that the polygon whose number of sides is reduced satisfy the specified condition in operation 960, the apparatus 200 for geofencing service may additionally generate an intersection of extension lines on both sides of a vertex generated by the side number reduction and recalculate the area only for a shape formed by the additionally generated intersection in operation 980.

Thereafter, the apparatus 200 for geofencing service may repeat operations 950 to 960 and operation 970 or 980.

As described above, the apparatus 200 for geofencing service according to an embodiment may simplify a very complex polygon including a detailed area in a process of setting an emergency alert message service provided for a wide radius, such as a city, county, or district to a town, township, neighborhood or a narrow region within it, thereby reducing the amount of calculation required to identify the reception area of emergency alert messages.

In addition, the apparatus 200 for geofencing service according to an embodiment may reduce the number of coordinates expressing the reception area while minimally enlarging the range of the emergency alert message reception area, thereby providing a method for effectively processing calculations.

The various embodiments of the disclosure and terminology used herein are not intended to limit the technical features of the disclosure to the specific embodiments, but rather should be understood to cover all modifications, equivalents, and alternatives falling within the spirit and scope of the invention. Like numbers refer to like elements throughout the description of the drawings. The singular forms preceded by “a,” “an,” and “the” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof. Terms such as “first,” “second,” etc. are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” The module may be an integrally configured component or a minimum unit or part of the integrally configured component that performs one or more functions. For example, according to one embodiment, the module may be implemented in the form of an application-specific integrated circuit (ASIC).

The various embodiments of the present disclosure may be realized by software (e.g., a program) including one or more instructions stored in a storage medium (e.g., a memory 240 in FIG. 2, such as an internal memory or external memory,) that can be read by a machine (e.g., the apparatus for geofencing service). For example, a processor (e.g., the processor 250 of the machine (e.g., the apparatus for geofencing service) may invoke and execute at least one instruction among the stored one or more instructions from the storage medium. Accordingly, the machine operates to perform at least one function in accordance with the invoked at least one command. The one or more instructions may include codes generated by a compiler or codes executable by an interpreter. The machine-readable storage medium may be provided in the form of a non-transitory storage medium. Here, when a storage medium is referred to as “non-transitory,” it can be understood that the storage medium is tangible and does not include a signal (for example, electromagnetic waves), but rather that data is semi-permanently or temporarily stored in the storage medium.

According to one embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)), or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure 0 may be implemented in the form of software or hardware, such as a digital signal processor (DSP), a FPGA or an ASIC, and may perform predetermined functions. The “elements” are not limited to meaning software or hardware. Each of the elements may be configured to be stored in a storage medium capable of being addressed and configured to execute one or more processors. For example, the elements may include elements such as software elements, object-oriented software elements, class elements, and task elements, processes, functions, attributes, procedures, subroutines, segments of a program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above-described elements or operations may be omitted, or one or more other elements or operations may be added. Alternatively, or additionally, a plurality of elements (e.g., modules or programs) may be integrated into one element. In this case, the integrated element may perform one or more functions of each of the plurality of elements in a manner the same as or similar to that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

As is apparent from the above, according to various embodiments disclosed in this document, area information for transmitting information such as emergency alert messages can be efficiently set up. In addition, various effects that can be directly or indirectly identified through this document can be provided.

What is claimed is:

1. An apparatus for geofencing service, the apparatus comprising:
a memory; and
a processor functionally connected to the memory,
wherein the processor, when polygonal zone information related to a geographic area for transmitting specified information is set, reduces a number of sides of a polygon according to the set polygonal zone information using external extension lines of each side of the polygon,
determines an area corresponding to the polygon having the reduced number of side as a target area for transmitting the specified information, and
stores information related to the determined target area in the memory.

2. The apparatus of claim 1, wherein the processor forms the external extension lines for each side of the polygon, and includes shapes formed by intersections of the external extension lines as a part of the polygon in order of a small area within a specified condition to reduce the number of sides of the polygon.

3. The apparatus of claim 2, wherein the processor reduces the number of sides of the polygon while an enlargement area of the polygon caused by including the formed shapes is within a specified range.

4. The apparatus of claim 2, wherein the processor ends the reduction of the number of sides of the polygon when the number of the sides of the polygon is less than or equal to a specified threshold.

5. The apparatus of claim 2, wherein the processor, when reducing the number of sides of the polygon, repeatedly regenerates intersections using left and right extension lines of a vertex formed by the side number reduction, and
includes a shape with a smallest area among shapes formed by the regenerated intersections and previous intersections in the polygon within a range that satisfies the specified condition, to reduce the number of sides of the polygon.

6. The apparatus of claim 2, wherein the processor
moves and rotates the set polygon based on each side such that each side is aligned with a −x axis with one end located at an origin,
identifies an x value of an intersection of extension lines of the aligned sides in a +x-axis direction, and
calculates an area of a shape formed by the intersection using the x value.

7. The apparatus of claim 6, wherein the processor excludes an intersection having a −x value among the intersections of the extension lines of the aligned sides.

8. The apparatus of claim 6, wherein the processor, after identifying x values of the intersections of the external extension lines, performs a reverse rotation and a reverse translation on the set polygon to restore the set polygon to an original position.

9. The apparatus of claim 1, further comprising a communication module,
wherein the processor identifies at least one base station covering the target area through the communication module, and transmits the specified information and geographic location information of the target area to a plurality of user terminals accessed to the at least one base station through the at least one base station.

10. An apparatus for geofencing service, the apparatus comprising:
a communication module; and
a processor functionally connected to the communication module,
wherein the processor, upon receiving a geographical area related to transmission of specified information through the communication module, sets polygonal zone information including the geographical area,
reduces a number of sides of a polygon according to the set polygonal zone information using external extension lines of each side of the polygon,
determines a geographical area corresponding to the polygon having the reduced number of sides as an area for transmitting the specified information, and
transmits information about the determined geographical area to an external electronic device through the communication module.

11. The apparatus of claim 10, wherein the processor forms external extension lines for each side of the polygon, and includes shapes formed by intersections of the external extension lines as a part of the polygon in order of a small area within a specified condition to reduce the number of sides of the polygon.

12. The apparatus of claim 11, wherein the processor reduces the number of sides of the polygon in a range satisfying at least one condition among a first condition that an area enlargement of the polygon due to the reduction of the number of sides is within a specified range and a second condition that the number of sides of the polygon is less than or equal to a specified threshold.

13. The apparatus of claim 10, wherein the processor, when reducing the number of sides of the polygon, repeatedly regenerates intersections using left and right extension lines of a vertex formed by the side number reduction, and
includes a shape with a smallest area, among shapes formed by the regenerated intersections and previous intersections in the polygon within a range that satisfies a specified condition, to reduce the number of sides of the polygon.

14. The apparatus of claim 10, wherein the processor
moves and rotates the set polygon such that each side is aligned with a −x axis with one end located at an origin, and
calculates an area of a shape formed by each side using an intersection's x value in a +x-axis direction of an extension line of the aligned side in the moved and rotated polygon.

15. The apparatus of claim 14, wherein the processor excludes an intersection having a −x value among the intersections of the extension lines of each side.

16. A method for geofencing service, which is performed by at least one process, the method comprising:
setting polygonal zone information including a selected geographical area in relation to transmission of specified information;
reducing a number of sides of a polygon according to the set polygonal zone information using external extension lines of each side of the polygon;
determining a geographical area corresponding to the polygon having the reduced number of sides as a transmission target area of the specified information; and
storing information about the determined transmission target area.

17. The method of claim 15, wherein the reducing of the number of sides of the polygon includes
forming the external extension lines for each side of the polygon,
detecting a shape with a smallest area among shapes formed by intersections of the external extension lines within a specified condition, and
reducing the number of the sides of the polygon by including the detected shape as a part of the polygon.

18. The method of claim 17, wherein the reducing of the number of the sides of the polygon by including the detected shape as a part of the polygon includes
identifying whether at least one condition among a first condition and a second condition is satisfied, wherein the first condition is that an area of the polygon, enlarged to include the formed shapes, is within a specified range and the second condition is that the number of the sides of the polygon is less than or equal to a specified threshold, and
when the at least one conditions is satisfied, performing side number reduction on the polygon, and when the at least one condition is not satisfied, ending to reduce the number of sides of the polygon.

19. The method of claim 17, wherein the reducing of the number of the sides of the polygon by including the detected shape as a part of the polygon includes
when the number of sides of the polygon is reduced, regenerating intersections using left and right extension lines of a vertex formed by the side number reduction,
additionally detecting a shape with a smallest area among shapes formed by the regenerated intersections and previous intersections; and
including the additionally detected shape in a previous polygon to reduce the number of sides that form the included shape,
wherein the regenerating of the intersections and the reducing of the number of sides forming the shape is repeated within a range that satisfies the at least one condition.

20. The method of claim 17, wherein the detecting of the shape includes
moving and rotating the set polygon such that each side is aligned with a −x axis with one end located at an origin, and
calculating an area of a shape formed by each side using an intersection's x value in a +x-axis direction of an extension line of the aligned side in the moved and rotated polygon.
